(19) United States
(12) Patent Application Publication
(10) Pub. No.: US 2008/0300025 A1
(43) Pub. Date: Dec. 4, 2008

(54) METHOD AND SYSTEM TO CONFIGURE AUDIO PROCESSING PATHS FOR VOICE RECOGNITION

(75) Inventors: JIANMING J. SONG, BARRINGTON, IL (US); JUN TIAN, GRAYSLAKE, IL (US); FREDERICK J. ZIMBRIC, GURNEE, IL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/756,430

(22) Filed: May 31, 2007

(51) Int. Cl. H04M 1/00

(52) U.S. Cl. 455/569.1

(57) ABSTRACT

A system (100) and method (400) for configuring audio processing paths and subsequent data transmission method and link for voice recognition is provided. The system can include a headset (110) to determine a voice request type of a voice signal, configure an audio processing path of the voice signal in accordance with the voice request type, and a mobile device (160) to receive the voice request type and configure an audio processing path and data transmission of the voice signal in accordance with the voice request type for the purpose of achieving a high recognition accuracy with use of a Bluetooth headset in a hands-free mode.

### FIELD OF THE INVENTION

The present invention relates to mobile devices and, more particularly, to a method and system for audio path configuration.

### BACKGROUND

As voice recognition (VR) becomes a common functionality on mobile devices, and Bluetooth (BT) headsets become an accessory to the mobile devices, a truly hands-free/eye-free device interaction for mobile communications becomes a reality via voice user interface (UI). A typical use case with a BT headset and VR mobile device is that a user, while wearing the headset on his ear, can press a voice button on the headset and then issue a voice call command that is captured by the BT headset and then transmitted to the VR mobile device. The VR mobile device can receive and recognize the voice call command and proceed to place the call. In such regard, the BT headset and VR mobile device combination provides a safe and convenient way for using the mobile phone in the car, which may comply with government regulations.

However, voice recognition performance is significantly reduced when the user speaks into the BT headset, than when the user speaks directly into the VR mobile device. A need therefore exists for a system and method to configure audio processing paths between the BT headset and the VR mobile device to improve voice recognition performance.

### SUMMARY

One embodiment in accordance with the present disclosure is a headset communicatively coupled to a mobile device over a communication link. The headset can include an audio module to configure a first audio processing path of a voice signal in the headset for voice recognition and a second audio processing path of the voice signal in the headset for voice communication responsive to determining a voice request type. If the voice request type corresponds to a voice recognition request, the audio modules can adjust an encoding rate of the voice signal in the first audio processing path to produce high quality speech, and select a data rate of the communication link to correspond to the encoding rate of the voice signal in the headset to achieve a high voice recognition accuracy on the mobile device.

If the voice request type is for voice communication, the audio module can encode the voice signal at relatively low bit rate sufficient for human voice communication, for example this is typically done with a continuously variable slope delta modulation, or CVSD scheme to produce a lower quality baseband encoded voice signal. If the voice request type is for voice recognition, then a higher degree of voice quality preservation is required. For this purpose, the controller can bypass the baseband voice signal encoding and use a higher quality wide band speech codec, such as the Sub band codec supported by the Advanced Audio Distribution Profile (A2DP) or simply preserve the voice quality of the captured voice signal in a PCM format. It can also apply a higher sampling frequency (e.g. 16 KHz) to voice captured in the voice recognition session, and maintain the standard 8 KHz sampling frequency for voice communication application. The audio module can include a modulator to modulate the encoded voice signal if the voice request type corresponds to a voice communication request, or modulate the voice signal if the voice request type corresponds to a voice recognition request, to produce a modulated signal, and a transmitter to transmit the modulated signal and the voice request type. The context switching and signal processing scheme can preserve a quality and integrity of captured voice signal. Good recognition accuracy in the voice recognition operation can be maintained with minimal impact on voice communication sessions.

In one arrangement, the transmitter can be wirelessly coupled to a mobile device using a Bluetooth communication link. The audio module can transmit the voice signal with a higher quality to the mobile device at a higher data rate when the voice request type corresponds to voice recognition, and transmit the voice signal to the mobile device at a lower data rate with perceptually sufficient quality when the voice request type corresponds to voice communication. As one example, the transmitter can transmit the voice signal at data rate higher than 64 Kbits/s over an asynchronous connectionless (ACL) logical transport for voice recognition tasks, and a synchronous connection-oriented (SCO) logical transport for voice communication tasks, operating at 64 Kbits/s for a single channel of voice.

Another embodiment in accordance with the present disclosure is a mobile device communicatively coupled to a headset over a communication link. The mobile device can include an audio module to receive a voice signal and a corresponding voice request type from the headset, and configure a first audio processing path of the voice signal in the mobile device for voice recognition and a second audio processing path of the voice signal in the mobile device for voice communication in accordance with the voice signal type. If the voice request type corresponds to a voice recognition request, the audio modules can adjust a decoding rate of the voice signal within the first audio path to correspond to a data rate of the communication link to achieve a high voice recognition accuracy on the mobile device.

A voice recognition system operatively coupled to the demodulator that receives the voice signal along the first audio processing path if the voice request type is for voice recognition. The audio module can include an equalizer operatively coupled to the voice recognition system to compensate the distortion encountered in the signal processing and transmission prior to voice recognition, and an automatic gain system (AGS) operatively coupled to the voice recognition system to adjust a gain of the signal prior to voice recognition.

Another embodiment is a system that includes a headset and a mobile device. The headset can determine a voice request type of a voice signal, configure an audio processing path of the voice signal in accordance with the voice request type, and transmit the voice signal over a high data rate connection if the voice request type corresponds to voice recognition, or transmit the voice signal over a lower data rate connection if the voice request type corresponds to voice communication. The mobile device can receive the voice request type and configure an audio processing path of the voice signal in accordance with the voice request type. The high data rate connection can be an asynchronous connectionless (ACL) logical transport and the low data rate connection can be a synchronous connection-oriented (SCO) logical transport.

Another embodiment is a system that includes a channel protection method to enhance received voice data integrity and mitigate channel interferences encountered in the Bluetooth data transmission. This channel protection method can be one of those commonly adopted methods, ranging from a simple checksum method, cyclic redundancy check (CRC), and other more sophisticated error detection and correction methods. Unlike human voice communication session in which the data rate constraints and real time requirements limit the use of a powerful error detection/correction mechanism, for the voice recognition application, the bit errors encountered can be mitigated by sending the redundancy bits along with the voice data, or by resending the same portion of voice data from the source if an error is detected.

Yet another embodiment is a method for voice processing between a headset communicatively coupled to a mobile device over a variable rate communication link. The method can include determining a voice request type of a voice signal, configuring a first audio processing path of the voice signal if the voice request type corresponds to voice recognition, and configuring a second audio processing path of the voice signal for voice communication if the voice request type corresponds to voice communication. The method can include configuring a first voice recognition path of the voice signal in the headset if a voice request type corresponds to voice recognition by adjusting an encoding rate of the voice signal in the voice recognition path to produce high quality speech, and selecting a data rate of the communication link to correspond to the encoding rate of the voice signal in the headset to achieve a high voice recognition accuracy on the mobile device. The method can include configuring a second voice recognition path of the voice signal in the mobile device for voice communication if the voice request type corresponds to voice recognition by adjusting a decoding rate of the voice signal within the second voice recognition path to correspond to the data rate of the communication link, and presenting the voice signal to a voice recognition system for high performance recognition.

The first audio processing path can process the voice as a wideband signal and transmit the coded speech at a high data rate. The second audio processing path processes the voice as a baseband signal and transmits the data at a low data rate. In one aspect, a Bluetooth wireless communication link can be used to transmit and receive the voice signal. The method can include identifying a user request for voice recognition, switching to the first audio processing path to condition the voice signal for voice recognition, receiving a voice recognition confirmation, and switching to the second audio processing path to condition the voice signal for voice communications responsive to receiving the voice communication confirmation.

The configuring of the first audio processing path for voice recognition can be performed on a headset and comprises digitizing an acoustic signal to produce a digitized signal, modulating the digitized signal to produce a modulated signal, and transmitting the modulated signal and the voice request type. The method can include applying a range of wideband speech codecs (e.g. high data rate SBC) or simply a raw PCM data without going through a codec. This method also applies a higher sampling frequency (e.g. 16 KHz) to the voice signal intended for voice recognition, and maintain a standard 8 KHz sampling frequency for voice communication in the second audio processing path.

The configuring of the first audio processing path for voice recognition can also be performed on a mobile device and comprises receiving the wideband encoded or PCM modulated signal and the voice signal type. Received speech data is then decoded or directly used if the source data is in PCM format. The reconstructed speech data is then sent to the voice recognizer engine to be recognized. The method can include equalizing the voice signal prior to the step of sending the wideband decoded or demodulated signal to the voice recognition system, and automatically gain adjusting the voice signal prior to the step of sending the demodulated signal to the voice recognition system.

The configuring of the second audio processing path for voice communications can be performed on a headset and comprises digitizing an acoustic signal to produce a digitized signal, encoding the digitized signal to produce an encoded signal, modulating the encoded signal to produce a modulated signal, and transmitting the modulated signal and the voice signal type, all performing at a telephone bandwidth.(i.e. baseband).

The configuring of the second audio processing path for voice communications can also be performed on a mobile device and comprises receiving the modulated signal and the voice signal type, demodulating the modulated signal to produce a demodulated signal, and decoding the demodulated signal to produce a decoded signal for providing voice communication.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 depicts an exemplary mobile device communication system in accordance with an embodiment of the present invention;

FIG. 2 depicts an exemplary audio module of a headset in accordance with an embodiment of the present invention;

FIG. 3 depicts an exemplary audio module of a mobile device in accordance with an embodiment of the present invention; and

FIG. 4 depicts an exemplary method for configuring an audio processing path for voice recognition and voice communications in accordance with an embodiment of the present invention;

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “processor” can be defined as number of suitable processors, controllers, units, or the like that carry out a pre-programmed or programmed set of instructions. The terms “program,” “software application,” and the like as used herein, are defined as a sequence of instructions designed for execution on a computer system. The term “headset” can be defined as a device consisting of one or two earphones with a headband for holding them over the ears and sometimes with a mouthpiece attached. The term “mobile device” can be defined as a portable electronic communication device such as a cell phone. The term “voice recognition” can be defined as recognizing a portion of a voice signal. The term “voice communication” can be defined as the communicating of voice signals across a communication network. The term “audio module” can be defined as a processor or software component that configures audio paths within a headset or mobile device, or across a data communication link.

Broadly stated, embodiments of the invention are directed to a system and method to configure audio processing paths for a headset and mobile device for improving voice recognition performance. The method can include, at the headset, adjusting encoding rates within the audio processing paths, and selecting communication links having data rates corresponding to the encoding rates. The method can include, at the mobile device, selecting a decoding rate corresponding to the data rate of the communication link to decode the voice signal to a high voice quality signal, and then submitting the high voice quality signal to a voice recognition system for high accuracy recognition. The system can suppress voice degradation and voice recognition mismatch by providing high quality wideband speech (e.g. 16 KHz PCM) between a headset and mobile device, via a modified data link establishment and service. The system can bypass normal encoding and decoding operations to preserve a quality of the voice signal when a voice recognition task is requested. Alternatively, the system can increase an encoding rate to achieve high voice quality encoding, select a communication link that supports the increased encoding rate, transmit the high quality voice signal over the communication link, and decode the voice signal at the data rate of the communication link to provide high quality speech to the voice recognition system for improved recognition performance. As an example, the system can request a high data rate ACL (asynchronous connectionless link) that supports multiple data rates to transfer the high quality voice from the headset to the mobile device for voice recognition tasks. Gain control and equalization can also be applied to enhance voice quality to improve recognition.

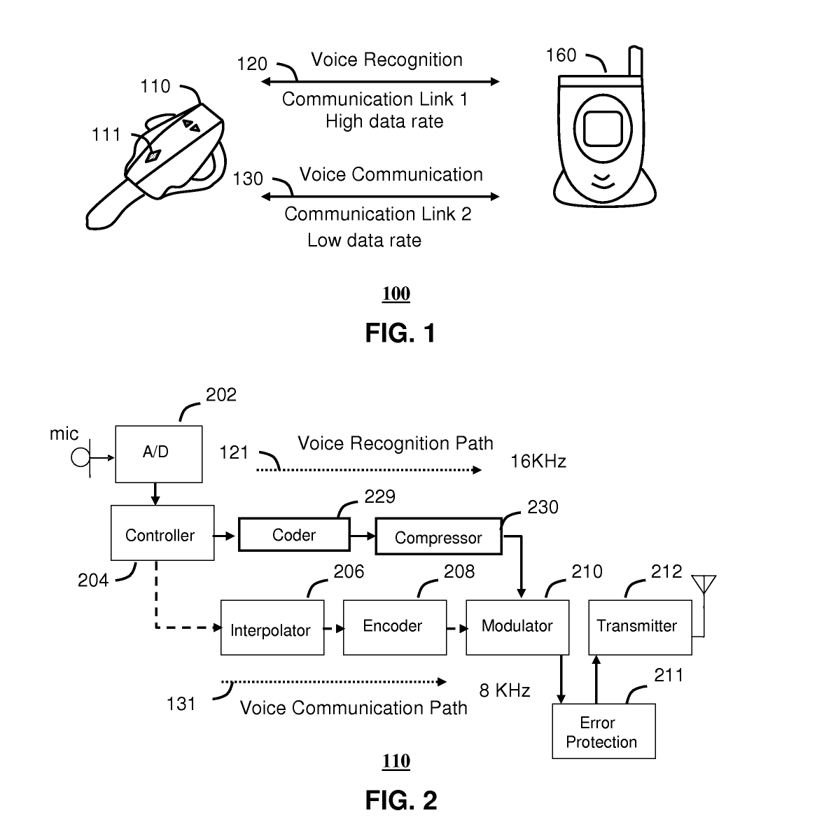

Referring to FIG. 1, an exemplary mobile device communication system 100 is shown. The mobile device communication system 100 can include a headset 110 communicatively coupled to a mobile device 160. The headset 110 can be an external earpiece, an in-the-canal earpiece, an earpiece attachment, an ear bud, a headset, or any other accessory device that can be attached to an ear. The head set 110 can include one or more soft buttons 111 to receive user input. The mobile device 160 can be a cell phone, personal digital assistant, laptop, car radio, portable music player, or any other suitable communication device.

Briefly, the headset 110 and mobile device 160 can communicate over a variable rate data communication link that supports multiple data rates. The headset 110 and the mobile device 160 can co-operatively select one of the communication links depending on the voice processing task. A voice processing task can correspond to a voice recognition task or a voice communication task. As illustrated, the headset 110 and mobile device 160 can send and receive voice signals over a high data rate communication link 120 for voice recognition tasks, or send and receive voice signals over a low data rate communication link 130 for voice communication tasks. The high data rate link 120 allows for a transmission of high data rate voice signals for voice recognition, and the low data rate link 130 allows for a transmission of lower data rate voice signals for regular voice communication related tasks. The data link can be a Bluetooth connection, a ZigBee connection, or any other wireless access technology that supports multiple data rates. The multiple data rates allow data and voice to be efficiently transmitted between the headset 110 and the mobile device 160 for various voice processing tasks. Control signals can also be sent between the devices using the wireless access technology. The data link connection is not limited to short-range wireless technologies.

Bluetooth is a short-range communications technology that can replace cables connecting portable and/or fixed devices while maintaining high levels of security. The key features of Bluetooth technology are robustness, minimal hardware dimensions, low power, and low cost. Bluetooth technology operates in the unlicensed industrial, scientific and medical (ISM) band at 2.4 to 2.485 GHz, using a spread spectrum, frequency hopping, full-duplex signal at a nominal rate of 1600 hops/sec. It has a low power rate of around 2.5 mW for most commonly used radio class 2 which makes it suitable for handheld devices. The Bluetooth version 1.2 supports 1 Mbps data rate and version 2.0+EDR (Enhanced Data Rate) supports up to 3 Mbps.

Bluetooth version 1.2 supports bidirectional communication between a master (e.g. mobile device 160) and a slave device (e.g. headset 110). There are two types of logical transports that can be used to establish the connection; synchronous connection-oriented (SCO) logical transport and asynchronous connectionless (ACL) logical transport. SCO is point-to-point bidirectional, symmetrical, and that has a constant bit-rate based on a fixed and periodic allocation of slots. SCO links require a pair of slots once every two, four or six slots, depending upon the SCO packet chosen for the link. The bit-rate is fixed to 64 Kb/s. SCO logical transport does not support the multiplexing of data streams. ACL logical transport is bidirectional, connectionless, asynchronous or isochronous and spans over 1, 3 or 5 slots. For ACL, Bluetooth uses a fast acknowledgment and retransmission scheme to ensure reliable transfer of data.

Both SCO link and ACL link are capable of transferring voice data. SCO has a fixed data rate of 64 Kb/s. ACL can support from 108.8 Kb/s to 433.9 Kb/s data rate depends on the packet type. To utilize a 16 KHz VR technology that benefits from a higher spectrum resolution and a wider spectrum content of a speech signal, a data rate of 256 Kbits/s or 128 Kbits/s is required, e.g. 16 (KHz)×16 (bits) or 16 KHz×8 bits. Some kinds of ACL packet types can fulfill this data rate requirement. Bluetooth has a very controlled channel access. Each node in a piconet is given a chance to transmit by the master: the presence of a polling mechanism to divide the piconet bandwidth among the slaves ensures that no ACL link gets starved. Under such an access mechanism, ACL links are sufficient to carry high-quality voice. The Bluetooth specifications define 7 kinds of ACL packets, three DM (data-medium rate) packets, three DH (data-high rate) packets and one AUX1 packet.

As shown in Table 1 below, DM3, DM5, DH3 and DH5 can support data rate of over 256 Kbits/s, and type DH1, DM3, DM5, DH3 and DH5 can support data rate of over 128 Kbits/s. Both DH and DM packets have CRC (cyclic redundancy check). DM packets have Forward error correction (FEC), but DH packets don't. FEC is a method of obtaining error control in data transmission in which the source (transmitter) sends redundant data and the destination (receiver) recognizes only the portion of the data that contains no apparent errors. DM packets have a lower data rate than DH packets but can provide a better error control mechanism. DM3 and DM5 are acceptable choices for transferring voice data for voice recognition (VR) applications which require maximum data rates of 256 Kbits/s.

TABLE 1

| | Payload | User | | | Symmetric |
|---|---|---|---|---|---|
| | Header | Payload | | | Max. Rate |
| Type | (bytes) | (bytes) | FEC | CRC | (Kbits/s) |
| DM1 | 1 | 0–17 | ⅔ | Yes | 108.8 |
| DH1 | 1 | 0–27 | No | Yes | 172.8 |
| DM3 | 2 | 0–121 | ⅔ | Yes | 258.1 |
| DH3 | 2 | 0–183 | No | Yes | 390.4 |
| DM5 | 2 | 0–224 | ⅔ | Yes | 286.7 |
| DH5 | 2 | 0–339 | No | Yes | 433.9 |

The headset 110 and the mobile device 160 can each configure an audio processing path within their respective devices to satisfy the data rate processing requirements associated with a selected communication link (e.g. high data rate link 120 or low data rate link 130). In particular, the headset 110 and the mobile device 160 can cooperatively configure an execution order of components in their respective audio processing path to process voice signals in accordance with a connectivity data rate. In a first configuration, the headset 110 and the mobile device 160 are configured for voice recognition tasks with one packet type from table 1. In a second configuration, the headset 110 and the mobile device are configured for voice communication tasks with 64 kb/s SCO packet type.

In accordance with one embodiment, the BT device 110 streams wideband speech content to the mobile device 160. In order to do so, the device sets up a streaming connection. During the set up procedure for establishing the streaming connection, the BT device 110 selects a suitable audio stream which exposes selectable parameters such as sampling frequency, codec type, data rate, speech equalization parameters, acoustic gain factor, as well as error protection method and parameters. During the set up, two kinds of services can be configured; one is an audio processing service capability for high accuracy voice recognition, and the other is a transport service capability for providing conversational voice communications. Once speech data stream is received and unpacked from a Bluetooth channel at a Sink point (i.e. receiver), a controller can send the data to a baseband decoder if the voice request type is for voice communication, and send the a higher data rate of speech content to either a wideband decoder or directly to the voice recognition engine if the voice request type is for voice recognition.

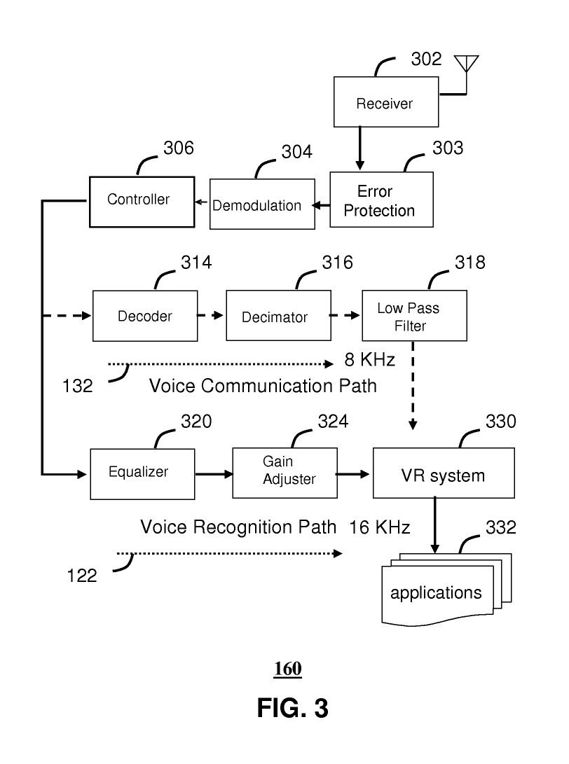

Referring to FIG. 2, an exemplary audio module of the headset 110 is shown. The audio module can include an analog to digital (A/D) converter 202 to capture an acoustic signal and generate the voice signal, and a controller 204 to determine the voice request type and selectively encode and modulate the voice signal in accordance with the voice request type. The controller 204 can select variable encoding rates of the encoder 208, and variable rates of the coder 229, which may be a voice encoder, music encoder, audio encoder, or media encoder that supports variable rates. It should also be noted that the encoder 208 may perform the functions of the coder 229, and can pass voice signal uncoded (e.g. PCM) or in a coded format. The controller 204 can select two audio processing paths: the voice recognition path 121 or the voice communication path 131. Along the voice communication path 131, the audio module can include an interpolator 206 to adjust a sampling rate of the voice signal to produce an interpolated signal prior to encoding, and an encoder 208 to encode the interpolated signal to produce an encoded voice signal if the voice request type corresponds to a voice communication request. Along the voice recognition path 121, the audio module can include the variable rate coder 229 and the compressor 230 to adjust a dynamic range of the voice signal to enhance features of the voice signal. In practice the compressor 230 may or may not be present. As an example, the compressor 230 can implement μ-law encoding, A-law encoding, and the coder 229 can be a wideband speech codec operating at a high acoustic resolution and data rate, such as the Sub Band Codec configured to support wideband audio (music), supported by the advanced audio Distribution Profile (A2DP), or any other suitable high quality wideband speech codec. The audio module can include a modulator 210 to modulate the encoded voice signal if the voice request type corresponds to a voice communication request, or modulate the voice signal if the voice request type corresponds to a voice recognition request, to produce a modulated signal. The audio module can include a forward error protection module 211 to increase the coding gain accuracy of the voice signal, which can implement check sum metrics, cyclic redundancy checks, or convolution coding techniques. The audio module can include a transmitter 212 to transmit the forward error corrected modulated signal and the voice request type. Notably, the controller 204 can configure the first audio processing path 121 for voice recognition by selecting a voice encoding rate that leads to high recognition accuracy and the second audio processing path 131 for voice communication responsive to determining a voice request type of the voice signal.

Referring to FIG. 3, an exemplary audio module of the mobile device 160 is shown. The audio module can include a receiver 302 to receive the voice signal and the corresponding voice request type from the headset, an error protection module 303 to correct any bit errors associated with the transmission of the voice signal over the communication link 120 or 130, a demodulator 304 to demodulate the voice signal, and a controller 306 that determines the voice request type and configures an audio processing path for the voice signal depending on the voice request type. Other components in the receive path can also be present such as a band-pass filter, a linear discriminator, an integrator, and threshold detector to pre-process the received voice signal, though not shown. The controller 306 can select two audio processing paths based on the voice type request: the voice recognition path 122 or the voice communication path 132. The voice communication path 132 can include a decoder 314 to decode the voice signal, a decimator 316 to adjust the sampling rate of the decoded signal, and a low pass filter 318 to recover the voice signal. The voice recognition path 122 includes an equalizer 320 to undo frequency distortions introduced by the headset 110, and a gain adjuster 324 to adjust a gain of the voice signal based on the amount of equalization. The gain adjuster 324 can also adjust the gain to a dynamic range appropriate for voice recognition. If the voice request type is voice communication, the controller 306 can send the voice signal along the voice communication path 132. If the voice request type is voice recognition, the controller 306 sends the voice signal along the voice recognition path 122.

The audio module can include a voice recognition system 330 that can receive voice signals from either the voice communication path 132 or the voice recognition path 122. In practice, the VR system 330 generally processes signals received from the voice recognition path 122. As an example, the VR system 330 can recognize a voice command (e.g. “call Jack”) and perform a task in response to recognizing the voice command (e.g. dial Jack's number). It should be noted that the voice recognition performance of the VR system is dependent on the quality of the voice signal received, which is a function of the level of voice encoding and the data rate. In general, the voice recognition performance is higher when minimal, or no, encoding and decoding operations are performed on the voice signal. The encoding and decoding operations degrade the voice signal in a manner that adversely affects recognition performance. Accordingly, the controller 306 configures the audio processing path of the voice signal in accordance with the type of voice type request received, which is either voice recognition or voice communication.

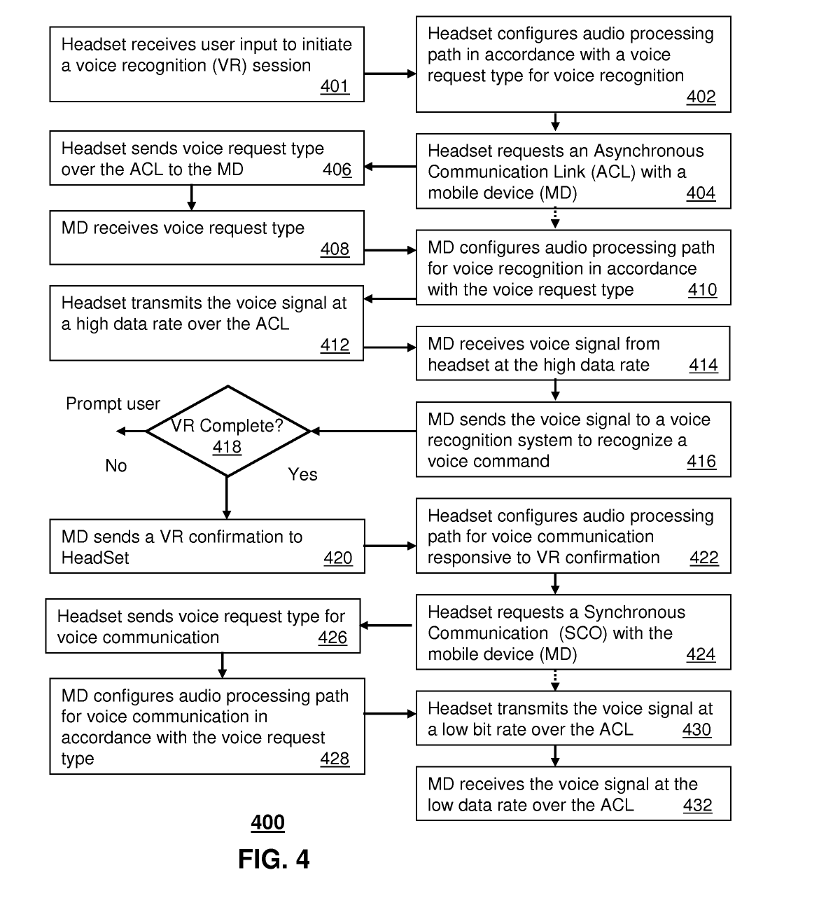

Referring to FIG. 4, a method 400 for configuring audio processing paths in a mobile device communication system for voice recognition is shown. The method 400 can be practiced with more or less than the number of steps shown, and is not limited to the order of the steps shown. To describe the method 400, reference will be made to FIGS. 2 and 3, although it is understood that the method 400 can be implemented in any other manner using other suitable components. The exemplary method 400 can start in a state wherein the headset 110 and the mobile device 160 are in a standby mode. In standby mode, the devices exchange voice and data over a low data rate Bluetooth connection using the low data rate link 130 (e.g. 128 Kbps, See Table 1).

In standby mode the Bluetooth components search for other Bluetooth-enabled devices by periodically performing a wakeup process during which it scans the surrounding environment for other Bluetooth-enabled devices. If the Bluetooth device encounters other Bluetooth-enabled devices during the scanning process and determines that a connection is needed, it can perform certain configurations and processes to establish either a high data rate ACL connection for voice recognition or a low data rate SCO connection for voice communication between the phone and the headset. Otherwise, the scanning task is turned off until a next wakeup process. The standby cycle of waking-up, scanning and turning off repeats typically once, twice, or four times every 1.28 seconds for the duration of the standby period. The standby mode preserves a battery power of the headset 110 and the mobile device 160. Notably, the method 400 can start in other modes as well, and is not limited to starting in a standby mode, which is only presented for example purposes.

At step 401, the headset 110 receives a user input to initiate a Voice Recognition (VR) session. For example, the user of the headset 110 may desire to place a call using voice recognition commands. The user can press the soft button 111 on the headset 110 to initiate a voice command request. Upon the headset 110 receiving the user input, the headset 110 at step 401 configures the audio processing path of the audio module in accordance with a voice request type for voice recognition. For example, referring back to FIG. 2, the controller 204 upon identifying the voice request type configures the audio processing path 121 to bypass the interpolator 206 and encoder 208.

At step 402, the headset 110 requests an Asynchronous Communication Link (ACL) for a high data rate Bluetooth connection with the mobile device 160. The ACL (e.g. high data rate link 120) can support data rates of 128 Kbps and 256 Kbps as shown in Table 1 to transfer voice signals from the headset 110 to the mobile device 160. The headset 110 can transmit the voice signal at a higher data rate within the same amount of time as an encoded voice signal at a lower data rate (e.g. 64 Kbps). Even though the raw PCM voice signal occupies more bandwidth (i.e. it is not encoded), more data can be transmitted due to the higher data rate of the ACL 120, thereby allowing the same amount of data to be transmitted per unit time. Upon receiving a confirmation that a high data rate ACL link 120 for Bluetooth communications is available, the headset 110 at step 406 sends the voice request type over the ACL to the mobile device 160.

At step 408, the mobile device 160 receives the voice request type, and, in response, at step 410, configures the audio processing path of the mobile device 160 audio module for voice recognition. For example, referring back to the audio module of the mobile device 160 in FIG. 3, the controller 306 configures the audio processing path 122 to bypass the decoder 314, decimator 316, and low-pass filter 318.

At step 412, the headset 110 proceeds to transmit the voice signal at the higher data rate (e.g. 265 Kbps) over the ACL 120 to the mobile device 160. Referring back to FIG. 2, the controller 204 sends the raw Pulse Code Modulated (PCM) data samples captured by the A/D 202 directly to the modulator 210, thus bypassing the interpolator 206 and encoder 208. The voice recognition path 121 preserves the original sampling rate (e.g 16 KHz) of the A/D converter 202. In contrast, the voice communication path 131 provides a lower sample rate (e.g. 8 KHz) and lower quality voice signal due to the interpolation and encoding. In the voice recognition configuration, the voice recognition path 121 prevents the voice signal from undergoing a lossy compression that would otherwise reduce the voice quality of the voice signal. The voice recognition path 121 preserves the original voice quality which results in improved recognition performance. The modulator 210 can then modulate the higher sample rate voice signal (e.g. 16 KHz) to produce a modulated signal that can be transmitted by the transmitter 212 at a high data rate (e.g. 256 Kbps).

At step 414, the mobile device 160 receives the voice signal from the headset 110, and at step 416 sends the voice signal to the voice recognition system 330 to recognize a voice command from the voice signal. More specifically, referring back to FIG. 3, the controller 306 sends the raw Pulse Code Modulated (PCM) data samples from the demodulated voice signal directly to the VR system 330, thus bypassing the decoder 314, decimator 316, and low-pass filter 318. The equalizer 320 and the gain adjuster 324 additionally enhance the voice signal prior to voice recognition to improve the recognition performance. The equalizer can compensate for any channel effects, or anomalies of the voice signal, occurring as a result of the communication processes.

The voice signal received by the recognition system 330 is a high quality signal since the voice signal did not undergo a combined encoding and decoding operation. Moreover, the voice signals are post-processed by the equalizer 320 and gain adjuster 324 to compensate for any distortions introduced by the headset 110. Furthermore, any latencies associated with encoding and decoding the voice signal are eliminated. Notably, the headset 110 did not perform an encoding operation on the voice signal due to the configuration of the audio processing path 121 set by the controller 204 in view of the voice request type. Accordingly, the mobile device 160 did not perform a decoding operation due to the configuration of the audio processing path set 122 by the controller 306 in view of the voice request type.

It should also be noted that the VR system 330 is trained on higher sample rate (e.g. PCM 16 KHz) voice signals instead of lower sample rate (e.g. 8 KHz) encoded voice signals to increase recognition performance. Moreover, the training set is matched to the testing set to further increase recognition performance. In particular, voice signals used for testing and training undergo the same processing steps. More specifically, the voice signals used in testing and training do not undergo a combined encoding (e.g. encoder 208 see FIG. 2) and decoding (e.g. encoder 314 see FIG. 3) operation. Table 2 below, presents experimental results of voice recognition performance when the training set and the testing set are matched and unmatched. Notably, the experimental error rate is significantly lower when the training set (PCM 16 KHz) matches the testing set (PCM 16 KHz), than when they are unmatched.

| | | | Digit string error rate |
|---|---|---|---|
| Training set | Testing set | Bit rate | (%) |
| PCM | PCM | 256 Kbits/s | 5.2 |
| PCM | ENCODED | 16 Kbits/s | 28.6 |

Returning back to FIG. 4 at step 418, if the VR system 330 did not recognize a voice command in the voice signal, the mobile device 160 can prompt the headset 110 for another voice signal, and in turn, the headset 110 can prompt the user for another spoken utterance. If the VR system 330 recognized the voice command, the mobile device 160 can send a VR confirmation to the headset 110 at step 420.

Upon receiving the VR confirmation, the headset 110 configures the audio processing path for voice communications as shown in step 422. This is performed in preparation for sending and receiving voice signals for voice communications, for example, when the call is connected and the parties communicate in a normal voice dialogue. Referring back to FIG. 2, the controller 204 switches the audio processing path from the voice recognition path 121 to the voice communication path 131. The voice communication path 131 includes the encoder 208 to reduce the data rate of the voice signals. In particular, the interpolator down samples the voice signal to a rate supported by the encoder 208. For example, if A/D 202 samples the acoustic voice signal captured by the microphone at a sampling rate of 16 KHz, and the encoder 208 encodes the voice signal at 8 KHz, the interpolator down samples the signal to 8 KHz. At step 424, the headset 110 then requests a synchronous connection-oriented (SCO) logical transport to send the lower data rate voice signals to the mobile device 160. Recall, the SCO link 130 provides a lower data rate connection (e.g. 64 Kbps) than the higher data rate (e.g. 256 Kbps) ACL link 120. In such regard, the system automatically configures both the headset and the mobile device for context awareness for voice recognition and voice communication. That is, the headset 110 determines the context (e.g. data rate channel or link capacity, supported mobile device decoder rates, voice request type, when selecting the link data rates (e.g. SCO, ACL).

Upon receiving a confirmation that the mobile device 160 has accepted the SCO link 130, the headset 110 sends to the mobile device 160 a voice request type for voice communication at step 426. In response, the mobile device 160 configures audio processing path for voice communication in accordance with the voice request type as shown in step 428. For example, referring back to FIG. 3, the controller 306 switches the audio processing path from the voice recognition path 122 to the voice communication path 132 for receiving regular voice communication data. The voice communication path 132 includes the decoder 315, the decimator 316, and the low-pass filter 318. At step 430, the headset 110 transmits the voice signal at a low data rate over the SCO link 130, which is received by the mobile device 160 at step 432. In this configuration, the headset 110 and the mobile device 160 can transmit data in accordance with normal operations. That is, the headset 110 encodes the voice signal, transmits the encoded voice signal to the mobile device, and the mobile device 160 decodes the encoded voice signal and audibly presents the decoded voice signal to the user.

Upon reviewing the aforementioned embodiments, it would be evident to an artisan with ordinary skill in the art that said embodiments can be modified, reduced, or enhanced without departing from the scope and spirit of the claims described below. There are numerous configurations for other media services that can be conceived for configuring media resources in a media network that can be applied to the present disclosure without departing from the scope of the claims defined below. In particular, various arrangement of handshaking between the headset 110 and the mobile device 160 are herein contemplated. For instance, as shown in step 404, the ACL connectivity request can inherently identify a voice recognition request, thereby bypassing the steps 406 and 408 for receiving and processing the voice type request. The mobile device 160 upon receiving the ACL request can immediately configure the audio path for voice recognition. Similarly, as shown in step 424, the SCO connectivity request can inherently identify a voice communication request, thereby bypassing the steps 426 and 428 for sending and processing the voice type request. The headset 110 upon receiving the VR confirmation can immediately configure the audio path for voice communications. Moreover, the mobile device 160 can immediately configure its audio path for voice communication responsive to transmitting the VR confirmation. These are but a few examples of modifications that can be applied to the present disclosure without departing from the scope of the claims stated below. Accordingly, the reader is directed to the claims section for a fuller understanding of the breadth and scope of the present disclosure.

In another arrangement a system is provided comprising a 1) headset to determine a voice request type of a voice signal, configure a first audio processing path of the voice signal in accordance with the voice request type by adjusting an encoding rate of the voice signal in the audio processing path to produce high quality speech, and selecting a data rate of a communication link to correspond to the encoding rate of the voice signal in the headset to achieve a high voice recognition accuracy on the mobile device, and transmit the voice signal over the communication link at the data rate selected, and 2) a mobile device to receive the voice request type and the voice signal over the communication link at the data rate selected, and configure a second audio processing path of the voice signal in accordance with the voice request type by adjusting a decoding rate of the voice signal within the second audio processing path to correspond to the data rate of the communication link, and presenting the voice signal to a voice recognition system for high performance recognition. The high data rate connection can be an asynchronous connectionless (ACL) logical transport and the low data rate connection can be a synchronous connection-oriented (SCO) logical transport. A channel protection module can enhance received voice data integrity and mitigate channel interferences encountered in the communication link. The channel protection modules can include a checksum method, cyclic redundancy check (CRC), or convolution coding check. The system can automatically configures both the headset and the mobile device for context awareness for voice recognition and voice communication.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A headset communicatively coupled to a mobile device over a communication link, the headset comprising
an audio module to configure a first audio processing path of a voice signal in the headset for voice recognition and a second audio processing path of the voice signal in the headset for voice communication responsive to determining a voice request type,
wherein, if the voice request type corresponds to a voice recognition request, the audio module adjusts an encoding rate of the voice signal in the first audio processing path to produce high quality speech, and selects a data rate of the communication link to correspond to the encoding rate of the voice signal in the headset to achieve a high voice recognition accuracy on the mobile device.

2. The headset of claim 1, wherein the audio module comprises
an analog to digital (A/D) converter to capture an acoustic signal and generate the voice signal;
a controller to determine the voice request type and selectively encode and modulate the voice signal in accordance with the voice request type;
an encoder to encode the voice signal to produce an encoded voice signal if the voice request type corresponds to a voice communication request;
a modulator to modulate the encoded voice signal if the voice request type corresponds to a voice communication request, or modulate the voice signal if the voice request type corresponds to a voice recognition request, to produce a modulated signal; and
a transmitter to transmit the modulated signal and the voice request type.

3. The headset of claim 1, wherein the controller generates a voice recognition request responsive to a user input.

4. The headset of claim 1, wherein the transmitter is wirelessly coupled to the mobile device using a Bluetooth communication link.

5. The headset of claim 1, wherein the audio module transmits the voice signal at a higher data rate when the voice request type corresponds to voice recognition, and transmits the voice signal at a lower data rate when the voice request type corresponds to voice communication.

6. The headset of claim 5, wherein the transmitter transmits the voice signal over an asynchronous connectionless (ACL) logical transport for voice recognition, and a synchronous connection-oriented (SCO) logical transport for the voice communication.

7. A mobile device communicatively coupled to a headset over a communication link, comprising:
an audio module to receive a voice signal and a corresponding voice request type from the headset, and configure a first audio processing path of the voice signal in the mobile device for voice recognition and a second audio processing path of the voice signal in the mobile device for voice communication in accordance with the voice signal type,
wherein, if the voice request type corresponds to a voice recognition request, the audio module adjusts a decoding rate of the voice signal within the first audio path to correspond to a data rate of the communication link to achieve a high voice recognition accuracy on the mobile device.

8. The mobile device of claim 7, wherein the audio module comprises
a receiver to receive the voice signal and the corresponding voice request type from the headset;
a demodulator to demodulate the voice signal;
a controller that determines the voice request type and sends the voice signal to a decoder if the voice request type is for voice communication, and bypasses the decoder if the voice request type is for voice recognition; and

9. The mobile device of claim 7, comprising
a voice recognition system operatively coupled to the demodulator, wherein the controller sends the voice signal to the voice recognition system if the voice request type is for voice recognition.

10. The mobile device of claim 7, comprising
an equalizer operatively coupled to the voice recognition system to equalize the voice signal prior to voice recognition.

11. The mobile device of claim 7, comprising
an automatic gain system (AGS) operatively coupled to the voice recognition system to adjust a gain of the signal prior to voice recognition.

12. The mobile device of claim 7, wherein the first audio processing path supports a higher data rate than the second audio processing path.

13. The mobile device of claim 7, wherein the audio module establishes an asynchronous connectionless (ACL) logical transport responsive to a voice recognition request, and establishes a synchronous connection-oriented (SCO) logical transport responsive to a voice communication request.

14. A method for voice processing between a headset communicatively coupled to a mobile device over a variable rate communication link, comprising:
configuring a first voice recognition path of the voice signal in the headset if a voice request type corresponds to voice recognition by adjusting an encoding rate of the voice signal in the voice recognition path to produce high quality speech, and selecting a data rate of the communication link to correspond to the encoding rate of the voice signal in the headset to achieve a high voice recognition accuracy on the mobile device; and
configuring a second voice recognition path of the voice signal in the mobile device for voice communication if the voice request type corresponds to voice recognition by adjusting a decoding rate of the voice signal within the second voice recognition path to correspond to the data rate of the communication link, and presenting the voice signal to a voice recognition system for high performance recognition.

15. The method of claim 14, comprising:
transmitting and receiving the voice signal using a Bluetooth wireless communication link.

16. The method of claim 14, comprising
identifying a user request for voice recognition;
switching to the first audio processing path to condition the voice signal for voice recognition;
receiving a voice recognition confirmation; and
switching to the second audio processing path to condition the voice signal for voice communications responsive to receiving the voice recognition confirmation.

17. The method of claim 14, wherein the first audio processing path is on a headset and the configuring comprises
digitizing an acoustic signal to produce a digitized signal;
modulating the digitized signal to produce a modulated signal; and
transmitting the modulated signal and the voice signal type.

18. The method of claim 14, wherein the second audio processing path is on a headset and the configuring comprises
digitizing an acoustic signal to produce a digitized signal;
encoding the digitized signal to produce an encoded signal;
modulating the encoded signal to produce a modulated signal; and
transmitting the modulated signal and the voice signal type.

19. The method of claim 14, wherein the first audio processing path is on a mobile device and the configuring comprises
receiving the modulated signal and the voice signal type;
demodulating the modulated signal to produce a demodulated signal;
sending the demodulated signal to a voice recognition system; and
responding with a voice recognition confirmation for providing voice recognition.

20. The method of claim 14, wherein the second audio processing path is on a mobile device and the configuring comprises
receiving the modulated signal and the voice signal type;
demodulating the modulated signal to produce a demodulated signal; and
decoding the demodulated signal to produce a decoded signal for providing voice communication.
